(19) United States
(12) Patent Application Publication
(10) Pub. No.: US 2026/0370948 A1
(43) Pub. Date: Nov. 19, 2026

(54) DRIVE DEVICE, CONTROL METHOD, AND STORAGE MEDIUM

(71) Applicant: CANON KABUSHIKI KAISHA, Tokyo (JP)

(72) Inventor: KIMIYA HOSHINO, Tokyo (JP)

(21) Appl. No.: 19/564,537

(22) Filed: Mar. 12, 2026

(30) Foreign Application Priority Data
May 16, 2025 (JP) 2025-082637

(51) Int. Cl. H04N 23/695; H04N 23/68

(52) U.S. Cl. CPC H04N 23/695; H04N 23/6812; H04N 23/687

(57) ABSTRACT

A drive device has a drive unit capable of rotating an image capturing unit in at least one direction, determines a deviation of a second image captured by the image capturing unit with respect to a first image captured by the image capturing unit, and corrects a phase deviation of a shaft of a motor of the drive unit in accordance with the results of the determination.

### BACKGROUND

### Field

The present disclosure relates to a drive device, a control method, a storage medium, and the like.

### Description of the Related Art

In the related art, outdoor remote camera universal heads are installed in locations that are difficult to access routinely, such as at high places, and camera image capturing is generally performed 24 hours a day, 365 days a year. Therefore, brushless motors having a long service life are often employed as motors for moving an image capturing direction of the camera in a horizontal direction (pan direction) and a vertical direction (tilt direction). However, there has been a problem in that encoders (position sensors) required to control the brushless motors have a shorter service life than the brushless motors.

Japanese Patent Laid-Open No. 2005-086607 describes a technology for realizing low power consumption by turning off power supply to a camera, motors, position sensors, and the like during periods of non-use by a user.

In addition, Japanese Patent Laid-Open No. 2010-130061 describes a technology for realizing low power consumption by cutting off power supply to horizontal and vertical rotation mechanisms and position sensors when the rotation mechanisms are not driven.

### SUMMARY

However, with the technologies in the related art disclosed in the foregoing publications, if a motor shaft has moved due to external factors such as vibration or strong wind during a period in which power supply to motors, rotation mechanisms, and position sensors is cut off, a phase deviation of the motor shaft cannot be corrected.

A drive device according to an aspect of the present disclosure has a drive unit capable of rotating an image capturing unit in at least one direction; determines a deviation of a second image captured by the image capturing unit with respect to a first image captured by the image capturing unit; and corrects a phase deviation of a shaft of a motor of the drive unit in accordance with the results of the determination. Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of a universal head camera device according to an embodiment.

FIGS. 2A and 2B are views showing an example of a configuration of a pan motor according to the embodiment.

FIGS. 3A and 3B are views showing an example of a configuration of a tilt motor according to the embodiment.

FIG. 4 is a flowchart showing an example of processing in a control method for controlling a universal head image capturing device according to the embodiment.

### DESCRIPTION OF THE EMBODIMENT

Hereinafter, an embodiment of the present disclosure will be described with reference to the drawings. However, the present disclosure is not limited to the following embodiment. In each diagram, the same reference signs are applied to the same members or elements, and duplicate description thereof will be omitted or simplified.

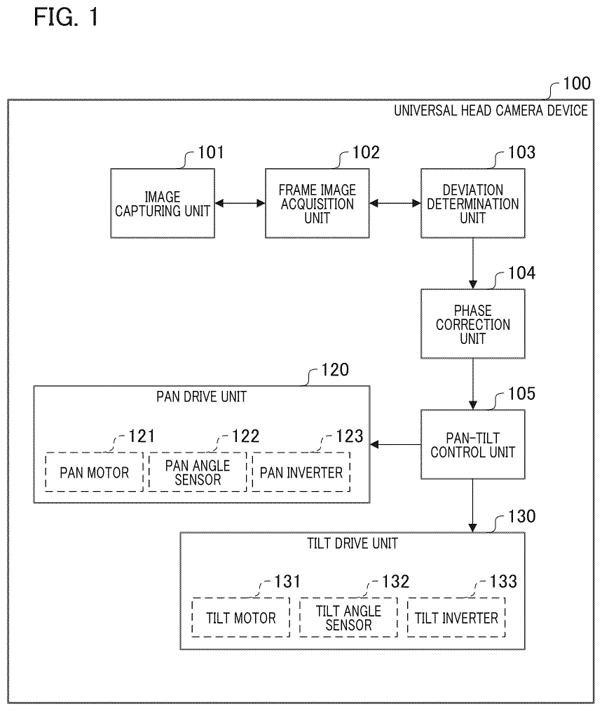

FIG. 1 is a diagram showing an example of a configuration of a universal head camera device 100 according to the embodiment. Some functional blocks shown in FIG. 1 are realized by causing a CPU or the like serving as a computer (not shown) included in the universal head camera device 100 to execute a computer program stored in a memory serving as a storage medium (not shown).

However, a part or all of them may be realized by hardware. A dedicated circuit (ASIC), a processor (reconfigurable processor, DSP), or the like can be used as hardware. In addition, each functional block shown in FIG. 1 need not be built into the same casing and may be constituted by separate devices connected to each other through signal paths.

The universal head camera device 100 in FIG. 1 includes an image capturing unit 101, a frame image acquisition unit 102, a deviation determination unit 103, a phase correction unit 104, a pan-tilt control unit 105, a pan drive unit 120, and a tilt drive unit 130.

The universal head camera device 100 of the present embodiment functions as a drive device (or a universal head image capturing device). In the present embodiment, an image capturing device with a universal head will be described as an example of the drive device. However, the drive device of the present embodiment also includes those in which a universal head and an image capturing device can be attached and detached.

In addition, in the present embodiment, an example in which a drive device has both a pan drive unit and a tilt drive unit will be described. However, the present embodiment also includes those having at least one of a pan drive unit and a tilt drive unit. That is, the drive device of the present embodiment need only be a device having a drive unit configured to be capable of rotating the image capturing unit in one direction (for example, at least one of a pan direction and a tilt direction).

In FIG. 1, the image capturing unit 101 includes image capturing lenses (not shown) including a focus lens (not shown), a zoom lens (not shown), and the like, and is capable of changing an image capturing angle of view. The image capturing unit 101 captures moving images and transmits images of respective frames of the moving images to the frame image acquisition unit 102 (which will be described below) as captured images. The image capturing unit 101 functions as an image capturing unit.

In addition, the image capturing unit 101 includes an image capturing sensor (not shown) for capturing images. For example, the image capturing sensor is a complementary metal oxide semiconductor (CMOS) image sensor or a charge coupled device (CCD) image sensor.

The foregoing image capturing sensor converts light incident through the image capturing lenses into an electrical video signal and inputs the signal to a signal processing circuit (not shown). In addition, the foregoing signal processing circuit performs signal processing such as A/D conversion and noise filtering with respect to a video signal input from the image capturing sensor.

The frame image acquisition unit 102 acquires a plurality of consecutive frame images captured by the image capturing unit 101 and acquires a first frame image serving as a reference and a second frame image serving as a determination target.

The deviation determination unit 103 compares the first frame image and the second frame image acquired by the frame image acquisition unit 102 and determines whether or not a deviation of the frame image has occurred. The deviation determination unit 103 functions as a determination unit configured to determine a deviation of a second image captured by the image capturing unit with respect to a first image captured by the image capturing unit.

Specifically, the deviation determination unit 103 compares, for example, pixels at the same coordinates in the first frame image and the second frame image, counts differing pixels, and determines that a deviation of the frame image has occurred if the number of differing pixels is equal to or larger than a predetermined threshold (determination value).

That is, the deviation determination unit 103 serving as a determination unit determines that a deviation has occurred based on a difference between the first image and the second image. It may be determined that a deviation has occurred if the total amount of difference is equal to or larger than a predetermined threshold (determination value).

Moreover, the deviation determination unit 103 acquires a setting state (amount of zoom and the like) of the image capturing lenses provided in the image capturing unit 101 via the frame image acquisition unit 102, and changes the predetermined threshold (determination value) for determining the foregoing number of differing pixels in accordance with the amount of zoom of the image capturing unit 101. That is, the deviation determination unit 103 serving as a determination unit changes the threshold used when determining occurrence of a deviation based on a difference, in accordance with the setting value for the lenses of the image capturing unit.

The phase correction unit 104 transmits information for correcting a phase deviation of a motor shaft in the pan drive unit 120 (which will be described below) and the tilt drive unit 130 (which will be described below) to the pan-tilt control unit 105 (which will be described below) on the basis of determination results (the presence or absence of a deviation, and the like) of the deviation determination unit 103. The phase correction unit 104 functions as a correction unit configured to correct a phase deviation of a shaft of a motor of the drive unit in accordance with the results of the determination.

The pan-tilt control unit 105 has a central processing unit (CPU) (not shown) serving as a computer, and a rotation position calculation unit (not shown). In addition, the pan-tilt control unit 105 has a read only memory (ROM) (not shown) and a random access memory (RAM) (not shown) serving as storage media.

The foregoing rotation position calculation unit calculates a rotational angle of a pan motor 121 (which will be described below) on the basis of a signal received from a pan angle sensor 122 (which will be described below). In addition, the rotation position calculation unit calculates a rotational angle of a tilt motor 131 (which will be described below) on the basis of a signal received from a tilt angle sensor 132 (which will be described below).

For example, if the number of edges per pulse output from the angle sensor is four, and the total number of pulses output from the angle sensor during one rotation of the motor is N, the total number of edges of pulses output from the angle sensor becomes “N×4”.

In addition, since the product of an angle per edge and the number of pole pairs of the motor corresponds to a mechanical angle through which a rotation shaft of the motor rotates, a mechanical angle θm through which the rotation shaft of the motor rotates is expressed by Equation 1 using the number P of pole pairs of the motor.

θm=P×360÷(N×4) (Equation 1)

Here, since θm corresponds to the mechanical angle of the rotation shaft (rotor) of the motor, the numerical value obtained by dividing θm by the number P of pole pairs corresponds to an electrical angle of the motor. In addition, the number P of pole pairs is a value specific to the motor, and the number N of pulses is a value specific to a rotary encoder. The mechanical angle θm is saved in a memory such as a RAM provided in the pan-tilt control unit 105.

In addition, on the basis of the number M of detected edges, a rotational phase θ of the rotor can be expressed by Equation 2. Here, θ0 is a rotational phase (initial phase) of the rotor when driving of the motor is started.

θ=θ0+M×P×360÷(N×4) (Equation 2)

The pan drive unit 120 can rotationally move an image capturing direction of the image capturing unit 101 in a horizontal direction (pan direction), and has the pan motor 121, the pan angle sensor 122, and a pan inverter 123.

For example, the pan motor 121 is a three-phase brushless DC motor, and is constituted by coils (not shown), a rotor of a permanent magnet (not shown), and the like. The coils are composed of three coils, such as a U-phase coil, a V-phase coil, and a W-phase coil, and the coils are disposed at positions forming mutual angles of 120 degrees with one another. The rotor has two poles of the permanent magnet and is disposed at the center of the coils. In addition, the rotor rotates by controlling currents flowing through the coils.

For example, the pan angle sensor 122 is an incremental rotary encoder, which detects the rotational angle of the rotor and transmits pulses corresponding to the rotation amount and the rotation speed of the pan motor 121 to the pan-tilt control unit 105.

The pan inverter 123 is composed of switching elements and controls currents supplied to the respective coils provided in the pan motor 121. Specifically, the pan inverter 123 drives the switching elements on the basis of a PWM control signal transmitted from the pan-tilt control unit 105 and performs feedback control of currents supplied to the respective coils provided in the pan motor 121.

The tilt drive unit 130 can rotationally move the image capturing direction of the image capturing unit 101 in a vertical direction (tilt direction), and has the tilt motor 131, the tilt angle sensor 132, and a tilt inverter 133.

For example, the tilt motor 131 is a three-phase brushless DC motor, and is constituted by coils (not shown) and a rotor of a permanent magnet (not shown). The coils are composed of three coils, such as a U-phase coil, a V-phase coil, and a W-phase coil, and the coils are disposed at positions forming mutual angles of 120 degrees with one another. The rotor has two poles of the permanent magnet and is disposed at the center of the coils. In addition, the rotor rotates by controlling currents flowing through the coils.

For example, the tilt angle sensor 132 is an incremental rotary encoder, which detects the rotational angle of the rotor and transmits pulses corresponding to the rotation amount and the rotation speed of the tilt motor 131 to the pan-tilt control unit 105.

The tilt inverter 133 is composed of switching elements and controls currents supplied to the respective coils provided in the tilt motor 131. Specifically, the tilt inverter 133 drives the switching elements on the basis of a PWM control signal transmitted from the pan-tilt control unit 105 and performs feedback control of currents supplied to the respective coils provided in the tilt motor 131.

In this manner, in the present embodiment, the phase correction unit is configured to be able to perform feedback control using an output of the angle sensor that corrects a phase deviation of the motor shaft of the drive unit in a state where a power supply of the universal head camera device 100 is turned on.

In the present embodiment, a configuration in which the number of pole pairs of a rotor 127 provided in the pan motor 121 is one has been described. However, the present embodiment can also be applied to configurations in which the number of pole pairs of the rotor 127 exceeds one.

Similarly, a configuration in which the number of pole pairs of a rotor 137 provided in the tilt motor 131 is one has been described. However, the present embodiment can also be applied to configurations in which the number of pole pairs of the rotor 137 exceeds one. In addition, a configuration in which the number of coils provided in the pan motor 121 and the tilt motor 131 is three has been described. However, the present embodiment can also be applied to configurations in which the number of coils exceeds three.

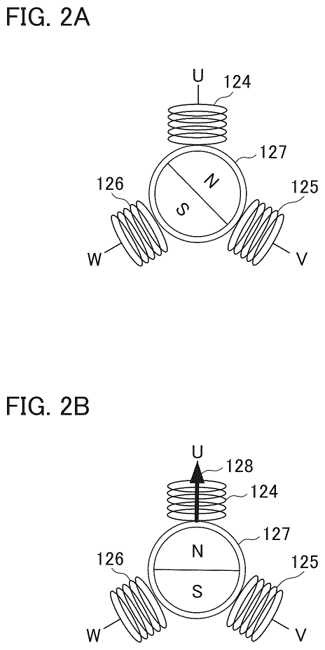

Next, FIGS. 2A and 2B are views showing an example of a configuration of the pan motor 121 according to the embodiment, and a method for correcting a phase deviation of the motor shaft in the pan drive unit 120 will be described.

FIG. 2A is a configuration diagram showing a state where the pan drive unit 120 is not controlling the rotor 127 (which will be described below). In FIG. 2A, the pan motor 121 has a U-phase coil 124, a V-phase coil 125, a W-phase coil 126, and the rotor 127.

The U-phase coil 124 is disposed at a position rotated by 120 degrees from the position of the V-phase coil 125. The V-phase coil 125 is disposed at a position rotated by 120 degrees from the position of the W-phase coil 126.

The W-phase coil 126 is disposed at a position rotated by 120 degrees from the position of the U-phase coil 124. That is, the U-phase coil 124, the V-phase coil 125, and the W-phase coil 126 are disposed at positions forming mutual angles of 120 degrees with one another.

The rotor 127 is constituted by a two-pole permanent magnet having an N pole and an S pole, and is disposed at the center of the U-phase coil 124, the V-phase coil 125, and the W-phase coil 126.

In the state of FIG. 2A, in the pan drive unit 120, since no current is supplied to the U-phase coil 124, the V-phase coil 125, and the W-phase coil 126, and the rotor 127 is not rotationally controlled, the rotor 127 is in a state where its position (phase) is not fixed.

Therefore, due to external factors such as vibration or strong wind, the rotor 127 may move, causing the phase of the motor shaft to deviate when the rotor 127 moves. In FIG. 2A, the N pole of the rotor 127 is rotated clockwise by 45 degrees with reference to the position of the U-phase coil 124.

In this manner, if the N pole of the rotor 127 has deviated from the position of the U-phase coil 124 (initial phase), the phase of the motor shaft in the pan drive unit 120 is deviated.

FIG. 2B is a configuration diagram showing a state where the pan drive unit 120 is controlling the rotor 127 to the initial phase. In FIG. 2B, the pan drive unit 120 supplies a current to the U-phase coil 124 such that the N pole of the rotor 127 is directed in the direction of the U-phase coil 124, thereby generating a current vector 128.

The N pole of the rotor 127 is attracted in the direction of the U-phase coil 124 by the current vector 128 and returns to the initial phase. In this manner, the N pole of the rotor 127 is returned to the initial phase to correct the phase deviation of the motor shaft.

That is, a phase deviation of the motor shaft can be corrected by shifting from the state of FIG. 2A to the state of FIG. 2B. In this manner, in the present embodiment, the drive unit has a rotor and a plurality of coils, and the phase correction unit 104 serving as a correction unit corrects a phase deviation by energizing a part of the plurality of coils.

In the present embodiment, a configuration in which the position where the N pole of the rotor 127 is directed in the direction of the U-phase coil 124 is set as the initial phase has been described. However, the present embodiment can also be applied to configurations in which the position where the N pole of the rotor 127 is directed in the direction of a coil other than the U-phase coil 124 is set as the initial phase.

In addition, a configuration in which the N pole of the rotor 127 is rotated by 45 degrees from the initial phase has been described. However, the present embodiment can also be applied to configurations in which the N pole of the rotor 127 is rotated by an angle other than 45 degrees from the initial phase.

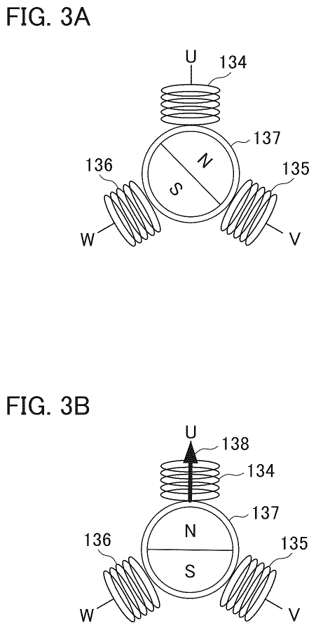

Next, FIGS. 3A and 3B are views showing an example of a configuration of the tilt motor 131 according to the embodiment, and a method for correcting a phase deviation of the motor shaft in the tilt drive unit 130 will be described.

FIG. 3A is a configuration diagram showing a state where the tilt drive unit 130 is not controlling the rotor 137 (which will be described below). In FIG. 3A, the tilt motor 131 has a U-phase coil 134, a V-phase coil 135, a W-phase coil 136, and the rotor 137.

The U-phase coil 134 is disposed at a position rotated by 120 degrees from the position of the V-phase coil 135. The V-phase coil 135 is disposed at a position rotated by 120 degrees from the position of the W-phase coil 136.

The W-phase coil 136 is disposed at a position rotated by 120 degrees from the position of the U-phase coil 134. That is, the U-phase coil 134, the V-phase coil 135, and the W-phase coil 136 are disposed at positions forming mutual angles of 120 degrees.

The rotor 137 is constituted by a two-pole permanent magnet having an N pole and an S pole, and is disposed at the center of the U-phase coil 134, the V-phase coil 135, and the W-phase coil 136.

In the state of FIG. 3A, in the tilt drive unit 130, since no current is supplied to the U-phase coil 134, the V-phase coil 135, and the W-phase coil 136, that is, the rotor 137 is not rotationally controlled, the rotor 137 is in a state where its position (phase) is not fixed.

Therefore, due to external factors such as vibration or strong wind, the rotor 137 may move, causing the phase of the motor shaft to deviate when the rotor 137 moves. In FIG. 3A, the N pole of the rotor 137 is rotated clockwise by 45 degrees with reference to the position of the U-phase coil 134.

In this manner, if the N pole of the rotor 137 has deviated from the position of the U-phase coil 134 (initial phase), the phase of the motor shaft in the tilt drive unit 130 is deviated.

FIG. 3B is a configuration diagram showing a state where the tilt drive unit 130 is controlling the rotor 137 to the initial phase. In FIG. 3B, the tilt drive unit 130 supplies a current to the U-phase coil 134 such that the N pole of the rotor 137 is directed in the direction of the U-phase coil 134, thereby generating a current vector 138.

The N pole of the rotor 137 is attracted in the direction of the U-phase coil 134 by the current vector 138 and returns to the initial phase. In this manner, the N pole of the rotor 137 is returned to the initial phase to correct the phase deviation of the motor shaft. That is, a phase deviation of the motor shaft can be corrected by shifting from the state of FIG. 3A to the state of FIG. 3B.

In the present embodiment, a configuration in which the position where the N pole of the rotor 137 is directed in the direction of the U-phase coil 134 is set as the initial phase has been described. However, the present embodiment can also be applied to configurations in which the position where the N pole of the rotor 137 is directed in the direction of a coil other than the U-phase coil 134 is set as the initial phase.

In addition, a configuration in which the N pole of the rotor 137 is rotated by 45 degrees from the initial phase has been described. However, the present embodiment can also be applied to configurations in which the N pole of the rotor 137 is rotated by an angle other than 45 degrees from the initial phase.

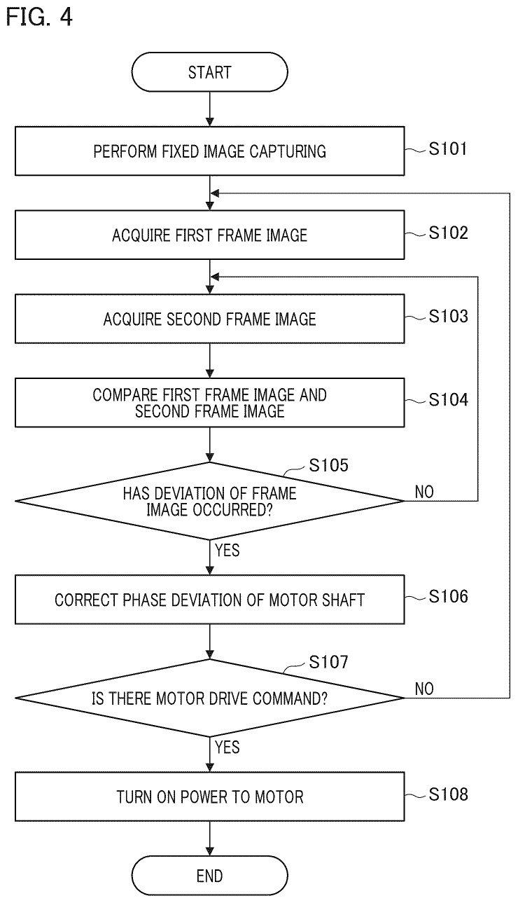

Next, FIG. 4 is a flowchart showing an example of processing in a control method for controlling a universal head image capturing device according to the present embodiment, and shows an example of processing for correcting a phase deviation of the motor shaft in the pan drive unit 120 and the tilt drive unit 130. Using FIG. 4, processing for correcting a phase deviation of the motor shaft in the pan drive unit 120 and the tilt drive unit 130 will be described.

When the CPU or the like serving as a computer inside the pan-tilt control unit 105 executes a computer program stored in the memory, operations of the respective steps of the flowchart in FIG. 4 are sequentially performed.

First, in Step S101, the image capturing unit 101 captures an image of a subject. In addition, in order not to rotationally move the image capturing direction of the image capturing unit 101 in the pan direction, the pan drive unit 120 cuts off power to the pan motor 121, the pan angle sensor 122, and the pan inverter 123.

Similarly, in order not to rotationally move the image capturing direction of the image capturing unit 101 in the tilt direction, the tilt drive unit 130 cuts off power to the tilt motor 131, the tilt angle sensor 132, and the tilt inverter 133.

Next, in Step S102, the frame image acquisition unit 102 acquires the first frame image serving as a reference.

Next, in Step S103, the frame image acquisition unit 102 acquires the second frame image serving as a determination target.

Next, in Step S104, the deviation determination unit 103 compares the first frame image and the second frame image acquired by the frame image acquisition unit 102. Specifically, the deviation determination unit 103 compares pixels at the same coordinates for all pixels in the first frame image in the second frame image and counts differing pixels.

Alternatively, the deviation determination unit 103 compares pixels at the same coordinates for peripheral pixels other than the central portion in the first frame image and the second frame image and counts differing pixels. That is, the deviation determination unit may determine that a deviation has occurred based on a difference between the peripheral portion of the first image and the peripheral portion of the second image. In this case as well, it may be determined that a deviation has occurred if the total amount of difference is equal to or larger than a predetermined threshold (determination value).

Next, in Step S105, the deviation determination unit 103 determines whether or not a deviation of the frame image has occurred in accordance with the determination results as to whether the number of differing pixels between the first frame image and the second frame image is equal to or larger than a predetermined threshold.

Here, Step S105 functions as a determination step of determining a deviation of the second image captured by the image capturing unit with respect to the first image captured by the image capturing unit.

In Step S105, if it is determined that a deviation of the frame image has occurred, the processing of Step S106 is executed. Meanwhile, in Step S105, if it is determined that no deviation of the frame image has occurred, the processing of Step S103 is executed again after a predetermined time has elapsed.

s above, in the present embodiment, if the number of differing pixels calculated in Step S104 is equal to or larger than a predetermined threshold, the deviation determination unit 103 determines that a deviation of the frame image has occurred. Moreover, the deviation determination unit 103 changes the predetermined threshold (determination value) in accordance with the amount of zoom of the image capturing unit 101. Accordingly, it is possible to cope with difference-pixel errors accompanying changes in the amount of zoom of the image capturing unit 101.

In Step S106, the phase correction unit 104 transmits correction information to the pan-tilt control unit 105 on the basis of the determination results of the deviation determination unit 103.

Further, the pan-tilt control unit 105 transmits a correction instruction to the pan drive unit 120 and the tilt drive unit 130 on the basis of the correction information transmitted from the phase correction unit 104. Further, the pan drive unit 120 supplies a current to the U-phase coil 124 on the basis of the correction instruction transmitted from the pan-tilt control unit 105, returns the N pole of the rotor 127 to the initial phase, and corrects a phase deviation of the motor shaft in the pan drive unit 120.

Similarly, the tilt drive unit 130 supplies a current to the U-phase coil 134 on the basis of the correction instruction transmitted from the pan-tilt control unit 105, returns the N pole of the rotor 137 to the initial phase, and corrects a phase deviation of the motor shaft in the tilt drive unit 130.

Here, Step S106 functions as a correction step of correcting a phase deviation of the shaft of the motor of the drive unit in accordance with the results of the determination in the determination step. In a phase correction step, a phase deviation of the motor shaft is corrected in accordance with the determination results of a deviation determination step.

Next, in Step S107, the pan-tilt control unit 105 determines whether or not there is a motor drive command for the pan drive unit 120 or the tilt drive unit 130. In Step S107, if it is determined that there is a motor drive command, the processing of Step S108 is executed.

Meanwhile, in Step S107, if it is determined that there is no motor drive command, the processing of Step S102 is executed again after a predetermined time has elapsed. In this manner, the phase correction unit 104 serving as a correction unit of the present embodiment periodically corrects a phase deviation in accordance with the results of the determination when feedback control of the motor is not being performed.

In Step S108, in order to rotationally move the image capturing direction of the image capturing unit 101 in the pan direction, the pan drive unit 120 turns on power to the pan motor 121, the pan angle sensor 122, and the pan inverter 123.

Similarly, in order to rotationally move the image capturing direction of the image capturing unit 101 in the tilt direction, the tilt drive unit 130 turns on power to the tilt motor 131, the tilt angle sensor 132, and the tilt inverter 133. Accordingly, feedback control using an output of the angle sensor that corrects a phase deviation of the motor shaft is started by the correction unit. Through the foregoing processing, the processing flow shown in FIG. 4 ends.

As above, in the present embodiment, before the motor power is turned on in Step S108, that is, when feedback control of the motor is not being performed, the phase correction unit 104 corrects a phase deviation of the motor shaft in accordance with the determination results of the deviation determination unit 103 serving as a determination unit.

As described above, according to the present embodiment, it is possible to provide a universal head camera that does not require correction of a phase deviation of the motor shaft by feedback control through activation of a position sensor before driving the motor.

Hereinabove, the present disclosure has been described in detail on the basis of a preferred embodiment thereof. However, the present disclosure is not limited to the foregoing embodiment. Various modifications and combinations of parts of the foregoing embodiment are possible based on the gist of the present disclosure, and these are not excluded from the gist of the present disclosure.

In order to realize a part or all of the control in the foregoing embodiment, a computer program for realizing the functions of the embodiment described above may be supplied to a drive device (universal head image capturing device) or the like via a network or various storage media. Further, a computer (alternatively, a CPU, an MPU, or the like) in the drive device (universal head image capturing device) or the like may read and execute the program.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiment(s) and/or that includes one or more circuits (e.g., application specific integrated circuit (ASIC)) for performing the functions of one or more of the above-described Embodiment(s), and by a method performed by the computer of the system or apparatus by, for example, reading out and executing the computer executable instructions from the storage medium to perform the functions of one or more of the above-described Embodiment(s) and/or controlling the one or more circuits to perform the functions of one or more of the above-described Embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-082637, filed May 16, 2025, which is hereby incorporated by reference wherein in its entirety.

What is claimed is:

1. A drive device comprising:
a drive unit capable of rotating an image capturing unit in at least one direction; and
one or more processors executing instructions to:
determine a deviation of a second image captured by the image capturing unit with respect to a first image captured by the image capturing unit; and
correct a phase deviation of a shaft of a motor of the drive unit in accordance with the results of the determination.

2. The drive device according to claim 1,
wherein the deviation is determined based on a difference between the first image and the second image.

3. The drive device according to claim 2,
wherein the deviation is determined based on a difference between a peripheral portion of the first image and a peripheral portion of the second image.

4. The drive device according to claim 2,
wherein the one or more processors further execute the instructions to change a threshold used in determining the deviation based on the difference in accordance with a setting value of a lens of the image capturing unit.

5. The drive device according to claim 1,
wherein the drive unit has a rotor and a plurality of coils, and
wherein the phase deviation is corrected by energizing a part of the plurality of coils.

6. The drive device according to claim 1,
wherein the one or more processors further execute the instructions to perform feedback control using an output of an angle sensor that corrects a phase deviation of the shaft of the motor, and
the phase deviation is corrected in accordance with the results of the determination when the feedback control is not being performed.

7. The drive device according to claim 6,
wherein the phase deviation is periodically corrected in accordance with the results of the determination when the feedback control is not being performed.

8. A control method performed by a drive device, the method comprising:
determining a deviation of a second image captured by an image capturing unit with respect to a first image captured by the image capturing unit; and
correcting, in accordance with the results of the determination, a phase deviation of a shaft of a motor of a drive unit capable of rotating the image capturing unit in at least one direction.

9. A non-transitory storage medium storing a control program of a drive device causing a computer to perform each step of a method for the drive device, the method comprising:
determining a deviation of a second image captured by an image capturing unit with respect to a first image captured by the image capturing unit; and
correcting, in accordance with the results of the determination, a phase deviation of a shaft of a motor of a drive unit capable of rotating the image capturing unit in at least one direction.
